(19) United States
(12) Patent Application Publication
(10) Pub. No.: US 2008/0173079 A1
(43) Pub. Date: Jul. 24, 2008

(54) Method for detecting engine rotation direction

(75) Inventors: Brian Gerard McGee, Chillicothe, IL (US); Michael Andrew Snopko, Lincoln, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/645,762

(22) Filed: Dec. 27, 2006

(51) Int. Cl. G01M 15/06

(52) U.S. Cl. 73/114.26

(57) ABSTRACT

A method for determining a direction of rotation of a rotatable shaft includes rotating a disk in synchronization with the rotatable shaft. The disk has a plurality of contiguous zones, and the zones include a set of first zones and at least one second zone. Each of the first zones has first and second areas. The method also includes generating a sensor signal using a sensor disposed adjacent the disk in response to the passing of the zones as the disk rotates. The sensor signal generated during the passing of the first zone is different than the sensor signal generated during the passing of the at least one second zone. The method further includes determining periods between the passing of the first areas of the first zones based on the sensor signal, detecting the at least one second zone based on the sensor signal, and determining the direction of rotation based on the periods determined after the detection of the at least one second zone.

### TECHNICAL FIELD

The present disclosure relates generally to a method for detecting a rotation direction of a rotatable shaft, and more particularly, to a method for detecting engine rotation direction.

### BACKGROUND

Fuel injected engines use injectors to introduce fuel into the combustion chambers of the engine. The injectors may be hydraulically or mechanically actuated with mechanical, hydraulic, or electrical control of fuel delivery. For example, a mechanically-actuated, electronically-controlled fuel injector includes a plunger movable by a cam-driven rocker arm to pressurize fuel within a bore of the injector. One or more electronic devices disposed within the injector are then actuated to deliver the pressurized fuel into the combustion chambers of the engine at one or more predetermined conditions.

In the field of internal combustion engine controls, stable and efficient engine operation may be maintained with accurate fuel injection timing. The timing of an internal combustion engine is highly dependent upon both the speed of rotation and the angular position of the engine at any instant in time. It is therefore desirable to determine both the crankshaft angle and rotational speed to a high degree of accuracy.

In certain internal combustion engines, it is possible for an external load to drive the engine in a rotational direction that is opposite from the normal rotational direction. Operation of the engine in such a manner may lead to serious mechanical damage and resultant engine failure. Therefore, it is desirable that a single system be capable of sensing not only rotational speed and angular displacement but also direction of rotation. By combining all three functions into a single system, system efficiency may increase.

One system for determining rotational speed, angular displacement, and direction of rotation is described in U.S. Pat. No. 6,208,131 (the '131 patent) issued to Cebis et al. The '131 patent describes an encoder wheel that rotates synchronously with an engine crankshaft. A sensor is positioned adjacent to the encoder wheel to sense the passage of two teeth on the encoder wheel past the sensor. The teeth are separated by an angle, and one of the teeth (a second tooth) has an angular extent that is a multiple of an angular extent of the other tooth (a first tooth). As a result, the signals produced by the sensor indicating the passage of the respective teeth may be distinguished from each other. Furthermore, the period of time that passes after sensing the first tooth until sensing the second tooth is used to determine whether the engine is rotating in a forward or reverse direction, since this period of time is shorter when the engine is rotating in one direction and longer when the engine is rotating in the opposite direction.

Although the system of the '131 patent may provide a method for determining the direction of rotation of the engine, this system requires a special encoder wheel with two unique teeth. Each tooth has a different predetermined angular extent, and the teeth are separated by a predetermined distance such that a unique timing pattern is produced in each of the forward and reverse directions. Manufacturing the encoder wheel and programming tooth pattern matching functions for the unique tooth pattern of the encoder wheel may be more complex and expensive. Furthermore, variations in engine operation may cause the signals corresponding to the passage of the two teeth to become similar to each other, which increases the difficulty in distinguishing between the two signals, thereby making it difficult to determine whether the engine is rotating in the forward or reverse directions.

The disclosed system is directed to overcoming one or more of the problems set forth above.

### SUMMARY OF THE INVENTION

In one aspect, the present disclosure is directed to a method for determining a direction of rotation of a rotatable shaft. The method includes rotating a disk in synchronization with the rotatable shaft. The disk has a plurality of contiguous zones, and the zones include a set of first zones and at least one second zone. Each of the first zones has first and second areas. The method also includes generating a sensor signal using a sensor disposed adjacent the disk in response to the passing of the zones as the disk rotates. The sensor signal generated during the passing of the first zone is different than the sensor signal generated during the passing of the at least one second zone. The method further includes determining periods between the passing of the first areas of the first zones based on the sensor signal, detecting the at least one second zone based on the sensor signal, and determining the direction of rotation based on the periods determined after the detection of the at least one second zone.

In another aspect, the present disclosure is directed to a system for determining a direction of rotation of a rotatable shaft. The system includes a disk rotatable in synchronization with the rotatable shaft having a plurality of contiguous zones. The zones include a set of first zones and at least one second zone. Each of the first zones has first and second areas. The system also includes a sensor disposed adjacent the disk for generating a sensor signal in response to the passing of the zones as the disk rotates and a controller coupled to the sensor. The sensor signal generated during the passing of the first zone is different than the sensor signal generated during the passing of the at least one second zone. The controller is configured to receive the sensor signal from the sensor, determine periods between the passing of the first areas of the first zones based on the sensor signal, detect the at least one second zone based on the sensor signal, and determine the direction of rotation based on the periods determined after the detection of the at least one second zone.

In yet another aspect, the present disclosure is directed to a method for determining a direction of rotation of an engine. The method includes rotating a disk in synchronization with a shaft of the engine. The disk has a plurality of contiguous zones of approximately equal angular extent, and the zones include a set of first zones and at least one second zone. Each of the first zones have first and second areas, and the first zones are different than the at least one second zone. The method also includes generating a sensor signal using a sensor disposed adjacent the disk in response to the passing of the zones as the disk rotates, determining periods between the passing of the first areas of the first zones based on the sensor signal, and determining the direction of rotation based on the determined periods.

### BRIEF DESCRIPTION OF THE DRAWINGS

FIG. 1 is a schematic and diagrammatic illustration of an internal combustion engine and a fuel system in accordance with an exemplary embodiment;

FIG. 2 is a schematic illustration of a disk connected to the engine of FIG. 1 in accordance with an exemplary embodiment;

FIG. 3 is a graph plotting tooth period, engine speed, and tooth position as a function of crank angle in accordance with an exemplary embodiment;

FIG. 4 is a flow chart illustrating a method of determining engine rotation direction in accordance with an exemplary embodiment; and

FIG. 5 is a flow chart illustrating a method of determining engine rotation direction in accordance with another exemplary embodiment.

### DETAILED DESCRIPTION

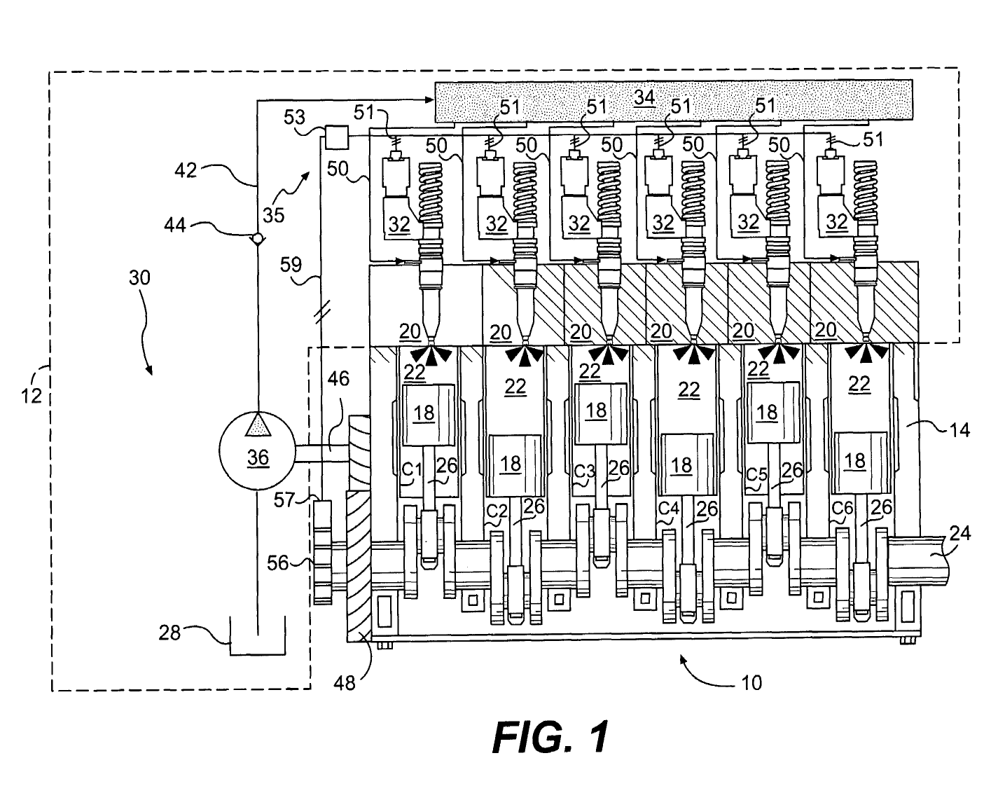

FIG. 1 illustrates an exemplary embodiment of an engine 10 and a fuel system 12. For the purposes of this disclosure, the engine 10 is depicted and described as a four-stroke diesel engine. One skilled in the art will recognize, however, that the engine 10 may be any other type of multicylinder internal combustion engine such as, for example, a gasoline or a gaseous fuel-powered engine. The engine 10 may include an engine block 14 that defines a plurality of cylinders C1-C6, a piston 18 slidably disposed within each cylinder C1-C6, and a cylinder head 20 associated with each cylinder C1-C6.

The cylinders C1-C6, the pistons 18, and the cylinder heads 20 may form combustion chambers 22. In the illustrated embodiment, the engine 10 includes six combustion chambers 22. However, it is contemplated that the engine 10 may include a greater or lesser number of the combustion chambers 22 and that the combustion chambers 22 may be disposed in an “in-line” configuration, a “V” configuration, or any other suitable configuration. The engine 10 may include a crankshaft 24 that is rotatably disposed within the engine block 14. A connecting rod 26 may connect each piston 18 to the crankshaft 24 so that a sliding motion of the piston 18 within each respective cylinder C1-C6 results in a rotation of the crankshaft 24. Similarly, a rotation of the crankshaft 24 may result in a sliding motion of the piston 18.

For the exemplary six-cylinder engine 10, each piston 18 is at a top dead center (TDC) position twice during each 720° four-stroke cycle, and at one of these two TDC positions, the associated cylinder C1-C6 starts its power stroke. The order for firing cylinders C1-C6 of a six-cylinder engine is 1-5-3-6-2-4. A power stroke occurs every 120° of rotation. Thus, cylinder C1 starts its power stroke at 0°, cylinder C5 at 120°, cylinder C3 at 240°, cylinder C6 at 360° (0°), cylinder C2 at 480° (120°), and cylinder C4 at 600° (240°). Alternatively, for a four-cylinder engine, a power stroke occurs every 180° of rotation.

The fuel system 12 may include components that cooperate to deliver injections of pressurized fuel into each combustion chamber 22. Specifically, the fuel system 12 may include a tank 28 configured to hold a supply of fuel, a fuel pumping arrangement 30 configured to pressurize the fuel and direct the pressurized fuel to a plurality of fuel injectors 32 by way of a manifold 34, and a control system 35. The fuel pumping arrangement 30 may include one or more pumping devices that function to increase the pressure of the fuel and direct one or more pressurized streams of fuel to the manifold 34. In one embodiment, the fuel pumping arrangement 30 includes a low pressure source 36, e.g., a transfer pump configured to provide low pressure feed to the manifold 34 via a fuel line 42. A check valve 44 may be disposed within the fuel line 42 to provide a one-directional flow of fuel from the fuel pumping arrangement 30 to the manifold 34. It is contemplated that the fuel pumping arrangement 30 may include additional and/or different components than those listed above such as, for example, a high pressure source disposed in series with the low pressure source 36. The low pressure source 36 may be operably connected to the engine 10 and driven by the crankshaft 24. For example, a pump driveshaft 46 of the low pressure source 36 is shown in FIG. 1 as being connected to the crankshaft 24 through a gear train 48. It is contemplated, however, that the low pressure source 36 may alternatively be driven electrically, hydraulically, pneumatically, or in any other appropriate manner.

The fuel injectors 32 may be disposed within the cylinder heads 20 and connected to the manifold 34 by way of a plurality of fuel lines 50. Each fuel injector 32 may be operable to inject an amount of pressurized fuel into an associated combustion chamber 22 at predetermined times, fuel pressures, and quantities. The timing of fuel injection into the combustion chamber 22 may be synchronized with the motion of the piston 18 within each respective cylinder C1-C6. For example, fuel may be injected as the piston 18 nears the TDC position in a compression stroke to allow for compression-ignited-combustion of the injected fuel. Alternatively, fuel may be injected as the piston 18 begins the compression stroke heading towards the TDC position for homogenous charge compression ignition operation. Fuel may also be injected as piston 18 is moving from the TDC position towards a bottom-dead-center (BDC) position during an expansion stroke for a late post injection to create a reducing atmosphere for aftertreatment regeneration. In order to accomplish these specific injection events, the engine 10 may request an injection of fuel from the control system 35 at a specific start of injection (SOI) timing, a specific start of injection pressure, a specific end of injection (EOI) pressure, and/or may request a specific quantity of injected fuel.

The control system 35 may control operation of each fuel injector 32 in response to one or more inputs. In particular, the control system 35 may include a controller 53 that communicates with the fuel injectors 32 by way of a plurality of communication lines 51 and with a sensor 57 by way of a communication line 59. The controller 53 may be configured to control a fuel injection timing, pressure, and amount by applying a determined current waveform or sequence of determined current waveforms to each fuel injector 32 based on input from the sensor 57.

The timing of the applied current waveform or sequence of waveforms may be facilitated by monitoring an angular position of a disk 56 disposed on the crankshaft 24 via the sensor 57. In particular, the sensor 57 may be configured to sense an angular position, velocity, and/or acceleration of the crankshaft 24, as described below. From the sensed angular information of the crankshaft 24 and known geometric relationships, the controller 53 may be able to control the injection timing, pressure, and quantity of the fuel injectors 32. Alternatively, the disk 56 may be disposed on a camshaft (not shown) or other rotatable shaft of the engine 10 or connected to the engine 10.

The controller 53 may embody a single microprocessor or multiple microprocessors that include a means for controlling an operation of the fuel injectors 32. Numerous commercially available microprocessors can be configured to perform the functions of the controller 53. It should be appreciated that the controller 53 could readily embody a general machine or engine microprocessor capable of controlling numerous machine or engine functions. The controller 53 may include all the components required to run an application such as, for example, a memory, a secondary storage device, and a processor, such as a central processing unit or any other means known in the art for controlling the fuel injectors 32. Various other known circuits may be associated with the controller 53, including power supply circuitry, signal-conditioning circuitry, solenoid driver circuitry, communication circuitry, and other appropriate circuitry.

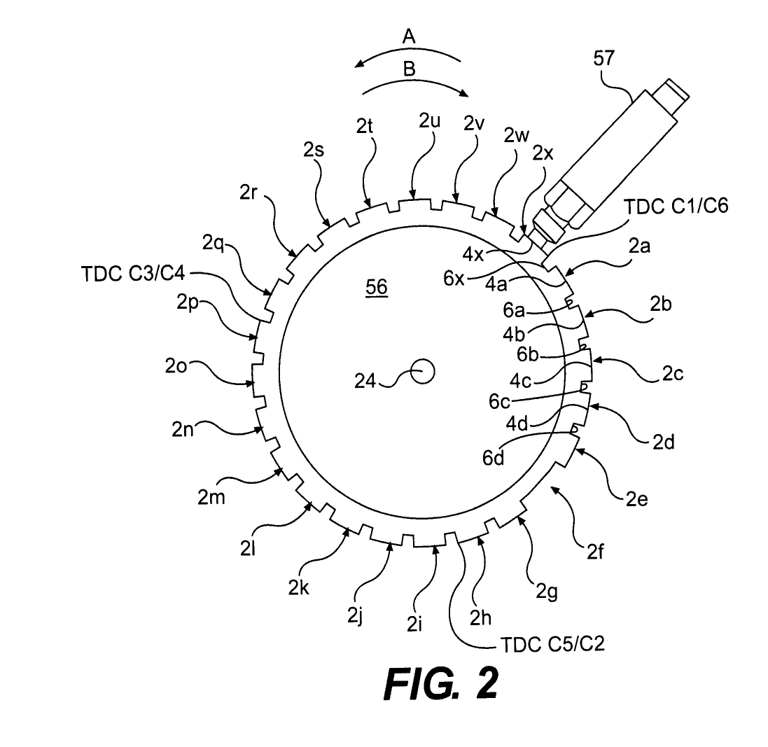

FIG. 2 illustrates the disk 56 that may be used for determining the speed, angular position, and/or direction of rotation of the crankshaft 24. The disk 56 may be in the form of a toothed wheel or gear that rotates in synchronism with the crankshaft 24 and has a plurality of contiguous circumferential zones 2a-2x of approximately equal circumferential distance (i.e., width) or angular extent. Each of the zones 2a-2e, 2g-2x has a first area 4a-4e, 4g-4x positioned at a first preselected radial distance from the center of the disk 56 and a second area 6a-6e, 6g-6x positioned at a second preselected radial distance from the center of the disk 56 different from the first radial distance. More specifically, each zone 2a-2e, 2g-2x includes a radially extending tooth 4a-4e, 4g-4x and a notch 6a-6e, 6g-6x each having a selected circumferential distance or angular extent. For example, zone 2a includes a tooth 4a and a notch 6a, while zone 2b includes a tooth 4b and a notch 6b. Hence, each notch 6a-6e, 6g-6x is disposed between adjacent teeth 4a-4e, 4g-4x.

In the exemplary embodiment shown in FIG. 2, each tooth 4a-4e, 4g-4x has an approximately equal width or angular extent, and each notch 6a-6e, 6g-6x has an approximately equal width or angular extent. For example, teeth 4a-4e, 4g-4x may occupy a certain percentage, e.g., approximately 50%, 80%, etc., of the corresponding zone width. Alternatively, zones 2a-2x may have different angular extents, teeth 4a-4e, 4g-4x may have different angular extents, and/or notches 6a-6e, 6g-6x may have different angular extents.

A single zone 2f is disposed between zones 2e and 2g, and has an area positioned at the second preselected radial distance from the center of the disk 56. More specifically, zone 2f may be characterized as having a notch that extends throughout the entire circumferential distance or angular extent of zone 2f. Zone 2f may be similar to zones 2a-2e, 2g -2x except that zone 2f does not include a tooth. Zone 2f of the disk 56 may be constructed by removing a tooth that is similar to teeth 4a-4e, 4g-4x from zone 2f. Thus, zone 2f may be characterized as having a “missing tooth.” Alternatively, instead of having a missing tooth, a portion of a tooth located in zone 2f may be milled down. Alternatively, more than one missing tooth and/or more than one partially milled down teeth may be provided on the disk 56.

The missing tooth may be used primarily as a base marker for determining the angle of rotation of the crankshaft 24. The crankshaft 24 may be mechanically timed to the engine 10 such that the piston 18 in cylinder C1 or C6 of the engine reaches the TDC position when the falling tooth edge of tooth 4x passes the sensor 57. The remaining engine pistons 18 of cylinders C2-C6 reach their respective TDC positions when the falling edges of teeth 4h, 4p, 4x, which are spaced at integer multiples of 120° about the disk 56 relative to the falling edge of tooth 4x, pass the sensor 57. As shown in the exemplary embodiment of FIG. 2, the disk 56 has 24 zones (zones 2a-2x), and the TDC position of one of the pistons 18 occurs after eight of the zones 2a-2x pass the sensor 57. Thus, in order, the piston 18 of cylinder C1 reaches the TDC position, zones 2a-2h pass the sensor 57, the piston 18 of cylinder C5 reaches the TDC position, zones 2i-2p pass the sensor 57, the piston 18 of cylinder C3 reaches the TDC position, zones 2q-2x pass the sensor 57, the piston 18 of cylinder C6 reaches the TDC position, zones 2a-2h pass the sensor 57, the piston 18 of cylinder C2 reaches the TDC position, zones 2i-2p pass the sensor 57, the piston 18 of cylinder C4 reaches the TDC position, zones 2q-2x pass the sensor 57, etc. For simplicity, in the exemplary embodiment, the TDC positions of cylinders C1-C6 align with the falling edges of teeth 4h, 4p, 4x passing the sensor 57. However, it is to be understood that each of the TDC positions of cylinders C1-C6 may align with other locations along the circumference of the disk 56. Furthermore, the disk 56 may include a lesser or greater number of zones, notches, and/or teeth.

During a forward rotation of the engine 10, the crankshaft 24 and the disk 56 rotate in the counterclockwise direction (arrow A) shown in FIG. 2. Rotation in the forward direction causes the sensor 57 to detect teeth in the order of tooth 4x, 4a, 4b, 4c, 4d, 4e, 4g, etc., as the zones 2x, 2a, 2b, 2c, 2d, 2e, 2g, etc., pass the sensor 57. Thus, the sensor 57 detects the falling edge of tooth 4x of zone 2x, then the falling edge of tooth 4a of zone 2a, then the falling edge of tooth 4b of zone 2b, and so on for the remaining zones 2c-2e, 2g -2w, and then the process is repeated.

During a reverse rotation of the engine 10, the crankshaft 24 and the disk 56 rotate in the clockwise direction (arrow B) shown in FIG. 2. Rotation in the reverse direction causes the sensor 57 to detect teeth in the order of tooth 4x, 4w, 4v, 4u, etc., as the zones 2x, 2w, 2v, 2u, etc., pass the sensor 57. Accordingly, the sensor 57 detects the teeth in reverse order compared to when the disk 56 is rotating in the forward direction. Thus, the sensor 57 detects the falling edge of tooth 4x of zone 2x, then the falling edge of tooth 4w of zone 2w, then the falling edge of tooth 4v of zone 2v, and so on for the remaining zones 2a-2e, 2g -2u, and then the process is repeated.

The sensor 57 is, for example, a Hall effect type sensor disposed at a preselected radial distance from the center of the disk 56 in sensing relation to the circumferential zones 2a-2x. The sensor 57 may be a passive or active sensor configured to deliver a digital signal (or series of digital signals) responsive to the passing of the circumferential zones 2a-2x. The passage of the teeth 4a-4e, 4g-4x and notches 6a-6e, 6g-6g affect the flux density sensed by the Hall effect sensor 57. Variations in flux density result in the sensor 57 delivering a time varying voltage signal with a frequency directly related to the rotational speed of the disk 56. For example, the signal from the sensor 57 may indicate when a rising and/or falling edge of each tooth 4a 4e, 4g-4x passes the sensor 57, and the controller 53 may receive the signal and determine the tooth periods between the passing of each tooth 4a-4e, 4g-4x based on the sensor signal. The tooth period may be calculated as the period of time that passes after the detection of the falling edge of one tooth (e.g., tooth 4x) until the detection of the falling edge of the next tooth (e.g., tooth 4a). The controller 53 may calculate a tooth period after detecting each falling tooth edge. Thus, the controller 53 may capture a tooth period associated with each tooth 4a-4e, 4g-4x. The controller 53 may use the captured tooth period information to determine the angular position, angular speed, and/or direction of rotation of the disk 56, as described below.

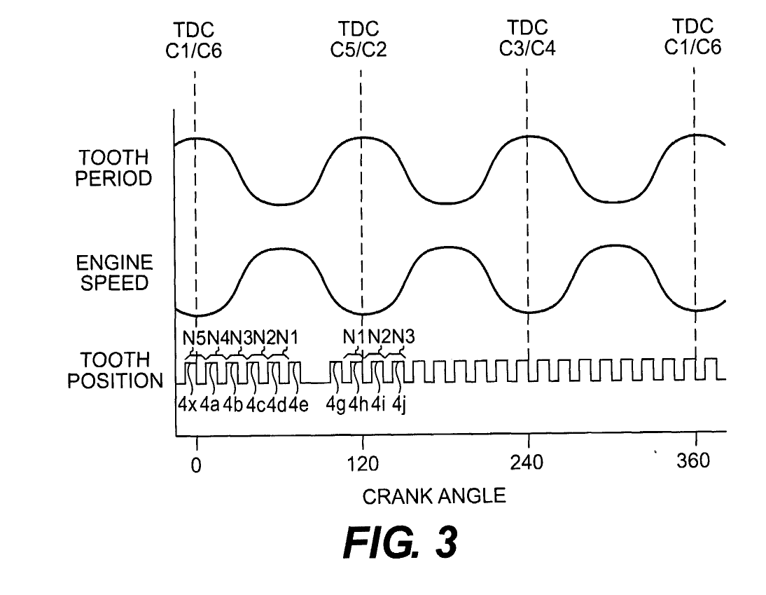

FIG. 3 illustrates a graph plotting tooth period, engine speed, and tooth position as a function of crank angle of crankshaft 24. During the normal operation of the engine 10, the engine speed is not constant. If the engine speed were constant, the crankshaft 24 would have a constant rotational speed, and since the teeth 4a-4e, 4g-4x and notches 6a-6e, 6g-6x are of approximately equal angular extent, the tooth periods would be approximately equal (except for the tooth period associated with the missing tooth). However, during the normal operation of the engine 10, the engine speed varies, for example, at the end of the compression stroke when the engine 10 does work, e.g., compressing a mixture of air and fuel, to bring the piston 18 to the TDC position. Thus, the engine speed may decrease temporarily when any of the pistons 18 approaches the TDC position at the end of the compression stroke. After reaching the TDC position, the engine speed may increase. For example, the mixture of air and fuel may combust, thereby releasing energy that pushes down on the piston 18 and causes the engine 10 to continue rotating. As a result, there is a local minimum in engine speed when any of the pistons 18 is at the TDC position, as shown in the graph of engine speed in FIG. 3.

The temporary decrease in engine speed corresponds to a temporary increase in tooth period. Thus, as shown in the graph of detected tooth period in FIG. 3, the tooth period sequence may be characterized as increasing as any of the pistons 18 approaches the TDC position, reaching a local maximum at around the TDC position, and decreasing just after the TDC position. This local minimum in engine speed and local maximum in tooth period is due to the power produced in the cylinders C1-C6 when the associated piston 18 approaches the TDC position. The controller 53 may detect this type of tooth period sequence to determine when one of the pistons 18 has reached the TDC position.

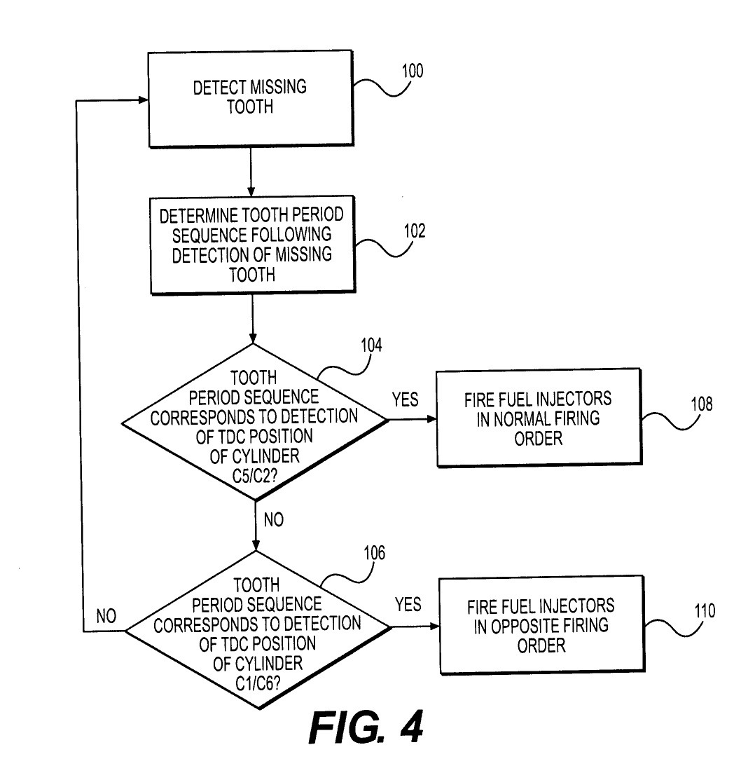

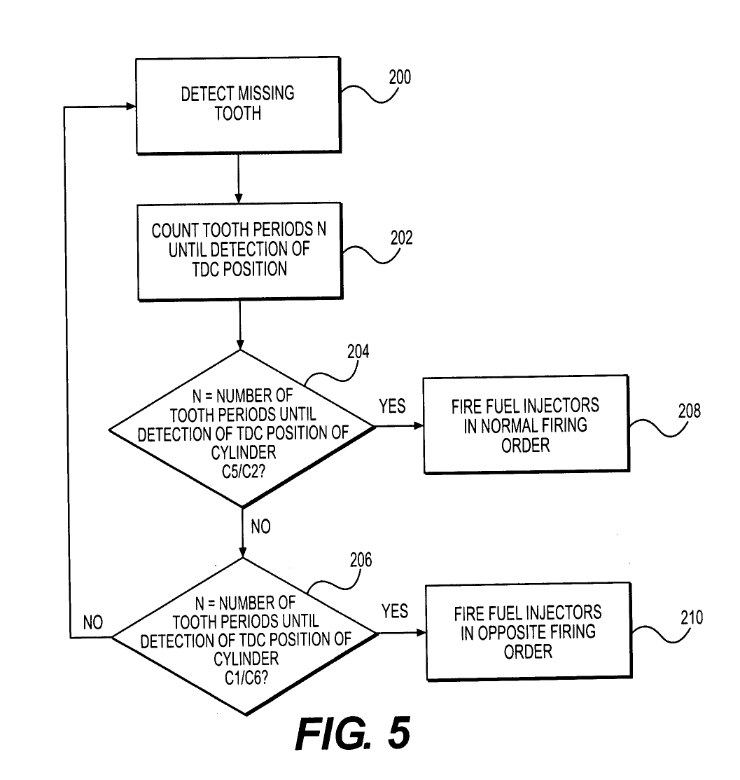

The detection of the missing tooth and of the TDC positions may be used as reference points for determining the direction of rotation of the engine 10. FIGS. 4 and 5 are flow charts illustrating exemplary methods for determining the direction of rotation of the engine 10.

In the exemplary method for determining the direction of rotation of the engine 10 shown in FIG. 4, the controller 53 detects the missing tooth in step 100. For example, the controller 53 may determine that the tooth period is longer than a predetermined time period or longer than the last measured tooth period or that the tooth period is within a predetermined range of time periods.

In step 102, the controller 53 captures a sequence of tooth periods following the detection of the missing tooth, i.e., zone 2f. The controller 53 may determine whether the engine 10 is rotating in a forward or reverse direction based on the captured tooth period sequence. In the exemplary embodiment, the controller 53 may capture a predetermined number of tooth periods, e.g., three tooth periods, immediately following the detection of the missing tooth. Alternatively, the controller 53 may capture a lesser or greater number of tooth periods immediately following the detection of the missing tooth.

The controller 53 may be programmed to determine characteristics of the tooth period sequence captured after detecting the missing tooth. The characteristics are determined based on the known location of the missing tooth in relation to the known location of the TDC positions of cylinders C I-C6. For example, as shown in FIGS. 2 and 3, the detection of the missing tooth, i.e., zone 2f, occurs between the detection of the TDC positions of cylinder C1/C6 and cylinder C5/C2. Thus; the controller 53 may be programmed to recognize that the engine 10 is rotating in the forward direction when cylinder C5 or C2 is the first cylinder to approach the TDC position after the detection of the missing tooth, and that the engine 10 is rotating in the reverse direction when cylinder C1 or C6 is the first cylinder to approach the TDC position after the detection of the missing tooth. Alternatively, the missing tooth, i.e., zone 2f, may be positioned at another location along the circumference of the disk 56, and therefore may be positioned between the TDC position of two different cylinders C1-C6.

Furthermore, the controller 53 may be programmed to recognize certain predetermined characteristics of the captured tooth period sequence depending on whether the engine 10 is rotating in the forward or reverse direction. In the exemplary embodiment, the missing tooth is not positioned equidistant between the TDC positions of cylinders C1/C6 and C5/C2. Therefore, the tooth period sequence following the detection of the missing tooth is different depending on the direction the engine 10 is rotating. For example, with the disk 56 shown in FIG. 2, the teeth 4a-4e, 4g-4x are positioned with respect to the TDC positions of cylinders C1/C6 and C5/C2 such that the captured tooth periods increase and then decrease immediately after the detection of the missing tooth if the engine 10 is rotating in the forward direction. Accordingly, the controller 53 may be programmed to recognize that, if the engine 10 is rotating in the forward direction, N1<N2>N3 where N1, N2, and N3 are the respective first, second, and third tooth periods captured after the detection of the missing tooth. Tooth period N1 corresponds to the tooth period detected between the falling edges of teeth 4g and 4h, and tooth period N3 corresponds to the tooth period detected between the falling edges of teeth 4i and 4j. Tooth period N2 corresponds to the tooth period detected between the falling edges of teeth 4h and 4i and is a local maximum tooth period that corresponds to the detection of the TDC position of cylinder C5/C2, as shown in FIG. 3.

With the disk 56 shown in FIG. 2, the teeth 4a-4e, 4g-4x are also positioned with respect to the TDC positions of cylinders C1/C6 and C5/C2 such that the captured tooth periods increase immediately after the detection of the missing tooth if the engine 10 is rotating in the reverse direction. The controller 53 may also be programmed to recognize that, if the engine 10 is rotating in the reverse direction, N1<N2<N3 where N1, N2, and N3 are the respective first, second, and third tooth periods captured after the detection of the missing tooth. Tooth period N1 corresponds to the tooth period detected between the falling edges of teeth 4e and 4d, tooth period N2 corresponds to the tooth period detected between the falling edges of teeth 4d and 4c, and tooth period N3 corresponds to the tooth period detected between the falling edges of teeth 4c and 4b. As shown in FIG. 3, tooth period N5, corresponding to the tooth period detected between falling edges of teeth 4a and 4x, is a local maximum tooth period. Thus, the tooth period increases until the detection of the next TDC position, i.e., the detection of the TDC position of cylinder C1/C6 when the local maximum tooth period N5 is detected. Thus, the difference in tooth period sequence, and specifically, the relationship between successive captured tooth periods, is used to distinguish the direction of rotation of the engine 10.

If the controller 53 detects the missing tooth and then the tooth period sequence corresponding to the detection of the TDC position of cylinder C5/C2, i.e., N1<N2>N3, (step 104; yes), then the controller 53 determines that the engine 10 is rotating in the forward direction. As a result, the controller 53 sends a signal to controller 53 to fire the fuel injectors 32 in their normal firing order (step 108).

If, in step 104, the controller 53 detects the missing tooth, but does not detect the tooth period sequence corresponding to the detection of the TDC position of cylinder C5/C2 (step 104; no), then the controller 53 determines if the tooth period sequence corresponds to the detection of the TDC position of cylinder C1/C6, i.e., N1<N2<N3 (step 106). If so (step 106; yes), then the controller 53 determines that the engine 10 is rotating in reverse. Then, the controller 53 may alter the firing order of cylinders C1-C6, e.g., by reversing the firing order of the fuel injections 32 if the engine 10 can be operated in reverse (step 110). Alternatively, fuel injection may be disabled if the engine 10 is unable to operate in reverse.

In step 106, the controller 53 may detect the missing tooth, but may not detect either tooth period sequence corresponding to the detection of the TDC position of cylinder C1/C6 or cylinder C5/C2 (step 106; no). For example, in cold start conditions, low battery conditions, or other situations that cause a variation in engine performance, the engine speed may drop, thereby causing the controller 53 to trigger a determination that a missing tooth has been detected. However, if the controller 53 has not also detected the tooth period sequences described above, then control may proceed back to step 100, and the controller 53 may detect the missing tooth again and may repeat the steps described above.

FIG. 5 illustrates another exemplary method for determining the direction of rotation of the engine 10. The controller 53 detects the missing tooth in step 200, as described above in connection with step 100. In step 202, the controller 53 counts the number of captured tooth periods until the controller 53 detects the next TDC position. Based on the number, the controller 53 may determine whether the engine is rotating in a forward or reverse direction.

For example, in the exemplary embodiment shown in FIGS. 2 and 3, the controller 53 may be programmed to recognize that there is one tooth 4g separating the missing tooth from the tooth 4h at the TDC position of cylinder C5/C2 and five teeth 4a-4e separating the missing tooth from the tooth 4x at the TDC position of cylinder C1/C6. Therefore, the controller 53 may be programmed to recognize that if one tooth period passes before the detection of a cylinder at the TDC position, i.e., a local maximum tooth period, then that cylinder is cylinder C5 or C2 and the engine 10 is rotating in the forward direction. The controller 53 may also be programmed to recognize that if five tooth periods pass before the detection of a cylinder in the TDC position, i.e., a local maximum tooth period, then that cylinder is cylinder C1 or C6 and the engine 10 is rotating in the reverse direction.

Accordingly, if the controller 53 detects the missing tooth and then one tooth period until the detection of a TDC position (step 204; yes), then the controller 53 determines that the engine is rotating in the forward direction. As a result, the controller 53 sends a signal to controller 53 to fire the fuel injectors 32 in their normal firing order (step 208).

If, in step 204, the controller 53 detects the missing tooth, but does not detect only one tooth period until the detection of a TDC position (step 204; no), then the controller 53 determines if it detects a TDC position after five tooth periods (step 206). If so (step 206; yes), then the controller 53 determines that the engine 10 is rotating in reverse. Then, the controller 53 may alter the firing order of cylinders C1-C6, e.g., by reversing the firing order of the fuel injections 32 if the engine 10 can be operated in reverse (step 210). Alternatively, fuel injection may be disabled if the engine 10 is unable to operate in reverse.

In step 206, the controller 53 may detect the missing tooth, but may not detect one or five tooth periods before detecting the next TDC position (step 206; no). This may occur, for example, in cold start conditions, low battery conditions, etc., as described above in connection with step 106. Then, control may proceed back to step 200, and the controller 53 may detect the missing tooth again and may repeat the steps described above.

Alternatively, the disk 56 may be disposed on the camshaft instead of the crankshaft 24. As a result, the disk 56 may rotate once during each four-stroke cycle, i.e., 720° of crankshaft rotation. Therefore, when performing either of the methods described above and shown in FIGS. 4 and 5, the controller 53 may be programmed to recognize that the TDC position first detected after detecting the missing tooth is specifically the TDC position of cylinder C5 when the engine 10 is rotating in the forward direction and the TDC position of cylinder C1 when the engine 10 is rotating in the reverse direction.

### INDUSTRIAL APPLICABILITY

The disclosed method for detecting rotation direction may be applicable to any machine that includes a rotatable shaft. The disclosed method for detecting rotation direction may detect the rotation direction of the rotatable shaft. For example, rotation direction of a crankshaft of an engine may be detected so that a firing of fuel injectors in the engine may be stopped or a firing order of the fuel injectors may be adjusted when the engine is rotating in the reverse direction.

The disk 56 rotates in synchronization with the engine crankshaft 24. As each tooth passes the sensor 57, a signal is transmitted to the controller 53. An active timing sensor may be implemented and may read variable tooth patterns, e.g., the tooth width to notch width ratio is 80/20, 60/40, and 50/50 in different sets of zones, on a special timing gear that acts as an encoder. Alternatively, the sensor 57 may be a passive timing sensor, which may read teeth 4a-4e, 4g-4x themselves, which is less costly. Teeth 4a-4e, 4g-4x may have a tooth width to notch width ratio of 50/50. Furthermore, a single sensor 57 may be implemented, which also may minimize costs and may require a less complex control program. Moreover, the disk 56 may be formed by a regular gear and does not require any special teeth or special tooth pattern, which may be easier to manufacture.

The controller 53 may calculate tooth periods, e.g., the periods of time that pass between the detection of the falling edges of two adjacent teeth 4a-4e, 4g-4x. At least one of the teeth on the disk 56 may be milled out to form the missing tooth, e.g., zone 2f. After detecting this missing tooth, the controller 53 monitors the sequence of tooth periods immediately following the detection of the missing tooth to determine whether the engine is rotating in the forward or reverse direction. Thus, the construction of the disk 56 with the missing tooth acting as the base marker may be less expensive and easier to manufacture.

The rotation direction of the engine 10 can be determined using the single sensor 57 and the disk 56 with the missing tooth by monitoring the tooth period sequence immediately following the detection of the missing tooth. Alternatively, the rotation direction of the engine 10 may be determined by detecting the passage of the missing tooth past the sensor 57 and counting the number of zones 2a-2e, 2g -2x that pass the sensor 57 thereafter until the detection of the TDC position, e.g., by detecting a local maximum tooth period. By implementing the disclosed methods for determining the rotation direction of the engine 10, the controller 53 and the sensor 57 may capture tooth periods at high engine speeds and may require less microprocessor execution time to run the tooth period capturing program stored in the controller 53.

Furthermore, detection of the TDC position of cylinders C1-C6 may also be useful to determine whether the controller 53 actually detected the missing tooth or if there is a variation in engine performance that causes the controller 53 to output that it detects the missing tooth without the missing tooth actually being sensed by the sensor 57. For example, under cold start conditions, hydraulic fluid in a transmission may have a low temperature, which increases viscosity of the oil. As a result, torsional forces may be imposed on the engine 10, which causes the engine speed to vary. Thus, the controller 53 may output that the missing tooth has been detected without the missing tooth actually being sensed by the sensor 57. In another example, the battery power may be so low that the engine speed drops, which may cause the controller 53 to confuse a drop in engine speed with the detection of the missing tooth.

It will be apparent to those skilled in the art that various modifications and variations can be made to the method for detecting engine rotation direction. Other embodiments will be apparent to those skilled in the art from consideration of the specification and practice of the disclosed method for detecting engine rotation direction. It is intended that the specification and examples be considered as exemplary only, with a true scope being indicated by the following claims-and their equivalents.

What is claimed is:

1. A method for determining a direction of rotation of a rotatable shaft, comprising:
rotating a disk in synchronization with the rotatable shaft, the disk having a plurality of contiguous zones, the zones including a set of first zones and at least one second zone, each of the first zones having first and second areas;
generating a sensor signal using a sensor disposed adjacent the disk in response to the passing of the zones as the disk rotates, the sensor signal generated during the passing of the first zone being different than the sensor signal generated during the passing of the at least one second zone;
determining periods between the passing of the first areas of the first zones based on the sensor signal;
detecting the at least one second zone based on the sensor signal; and
determining the direction of rotation based on the periods determined after the detection of the at least one second zone.

2. The method of claim 1, further including determining a change in period following the detection of the at least one second zone, the direction of rotation being determined based on the determined change in periods.

3. The method of claim 1, further including detecting a local maximum period after the detection of the at least one second zone, the direction of rotation being determined based on the detected local maximum period.

4. The method of claim 3, wherein the determining of the direction of rotation includes:
determining a difference in time between the detection of the local maximum period and the detection of the at least one second zone, and
determining the direction of rotation based on the determined time difference.

5. The method of claim 4, wherein the determination of the time difference includes determining a number of the periods between the detection of the local maximum period and the detection of the at least one second zone.

6. The method of claim 1, wherein the second zone and the second area of the first zone terminate at a first radial distance from a center of the disk, and the first area of the first zone terminates at a second radial distance from the center of the disk.

7. The method of claim 6, wherein the first area of the first zone is a tooth, the second area of the first zone is a notch, and the second zone is a notch.

8. The method of claim 1, wherein the first and second zones are of approximately equal angular extent.

9. The method of claim 1, wherein the period is measured by at least one of time and crank angle.

10. A system for determining a direction of rotation of a rotatable shaft, comprising:
a disk rotatable in synchronization with the rotatable shaft having a plurality of contiguous zones, the zones including a set of first zones and at least one second zone, each of the first zones having first and second areas;
a sensor disposed adjacent the disk for generating a sensor signal in response to the passing of the zones as the disk rotates, the sensor signal generated during the passing of the first zone being different than the sensor signal generated during the passing of the at least one second zone; and
a controller coupled to the sensor, the controller being configured to:
receive the sensor signal from the sensor,
determine periods between the passing of the first areas of the first zones based on the sensor signal,
detect the at least one second zone based on the sensor signal, and
determine the direction of rotation based on the periods determined after the detection of the at least one second zone.

11. The system of claim 10, wherein the controller is further configured to:
determine the change in period following the detection of the at least one second zone, and
determine the direction of rotation based on the determined change in periods.

12. The system of claim 10, wherein the controller is further configured to:
detect a local maximum period after the detection of the at least one second zone, and
determine the direction of rotation based on the detected local maximum period.

13. The system of claim 12, wherein the controller is further configured to:
determine a number of periods between the detection of the local maximum period and the detection of the at least one second zone, and
determine the direction of rotation based on the determined number of periods.

14. A method for determining a direction of rotation of an engine, comprising:
rotating a disk in synchronization with a shaft of the engine, the disk having a plurality of contiguous zones of approximately equal angular extent, the zones including a set of first zones and at least one second zone, each of the first zones having first and second areas, the first zones being different than the at least one second zone;
generating a sensor signal using a sensor disposed adjacent the disk in response to the passing of the zones as the disk rotates;
determining periods between the passing of the first areas of the first zones based on the sensor signal; and
determining the direction of rotation based on the determined periods.

15. The method of claim 14, further including:
detecting the at least one second zone based on the sensor signal; and
determining the direction of rotation based on the periods determined after the detection of the at least one second zone.

16. The method of claim 14, further including determining a change in period, the direction of rotation being determined based on the determined change in periods.

17. The method of claim 16, detecting a local maximum period, the direction of rotation being determined based on the detected local maximum period.

18. The method of claim 17, wherein the determining of the direction of rotation includes:
determining a difference in time between the detection of the local maximum period and the detection of the at least one second zone, and
determining the direction of rotation based on the determined time difference.

19. The method of claim 14, wherein the determined direction of rotation is a reverse direction of rotation, and the method further includes preventing fuel injectors of the engine from firing after determining that the direction of rotation is the reverse direction.

20. The method of claim 14, wherein the determined direction of rotation is a reverse direction of rotation, and the method further includes altering a firing order of fuel injectors of the engine after determining that the direction of rotation is the reverse direction.
